(19) United States
(12) Patent Application Publication
(10) Pub. No.: US 2003/0145208 A1
(43) Pub. Date: Jul. 31, 2003

(54) System and method for improving integrity and authenticity of an article utilizing secure overlays

(76) Inventors: Bruce A. Willins, East Northport, NY (US); Huayan Wang, Hauppauge, NY (US)

Correspondence Address: Mark I. Koffsky, Esq., Symbol Technologies, Inc., One Symbol Plaza, MS A-6, Holtsville, NY, 11742-1300, US

(21) Appl. No.: 10/144,163

(22) Filed: May 10, 2002

Related U.S. Application Data
(60) Provisional application No. 60/352,114, filed on Jan. 25, 2002.

(51) Int. Cl. H04L 9/00

(52) U.S. Cl. 713/176

(57) ABSTRACT

Described is a system and method for improving integrity and authenticity of an article utilizing secure overlays. In particular, an issuer verifies an identity of a customer and generates a digital representation of an identification document of the customer. The issuer also generates an cryptographic check sum as a function of the digital representation using a predetermined cryptographic algorithm and converts the digital representation and the cryptographic check sum into an overlay to be attached on the identification document. When the identity of the customer needs to be verified, the user converts the overlay into the cryptographic check sum and the digital representation and then checks integrity of the digital representation by decrypting the cryptographic check sum using a predetermined decrypting technology. The user also generates a first digital representation of the identification document and compares the digital representation and the further digital representation. If (a) the integrity of the digital representation is not violated and (b) the digital representation is substantially similar to the further digital representation, then an indication is generated indicating that the customer is verified.

### PRIORITY CLAIM

This application claims the benefit of U.S. Provisional Patent Application Serial No. 60/352,114 filed Jan. 25, 2002 and entitled “Using Secure Overlays for Article Integrity & Authenticity”. This application is expressly incorporated herein, in its entirety, by reference.

### BACKGROUND INFORMATION

Various articles, such as documents and cards, are used to authenticate individuals, provide demographic information about the individual, and to assign certain rights and/or privileges to the individuals who carrying these articles. The information on these articles may be altered. These alterations may be difficult to detect by visual inspection. Often these articles include a particular indicia or graphic to indicate the authenticity of the issuing authority. However, these indicia or graphics may be counterfeited with an accuracy that makes it difficult to detect the counterfeits.

There are several conventional technologies which address this issue by embedding certain securities within the articles. However, there are a number of disadvantages associated with conventional technologies, such as the cost, the bureaucratic hurdles, and the time to re-issue the documents. Moreover, to reproduce some of the articles requires specialized equipments and/or specially trained personnel to perform a verification procedure, and thus significantly raises the cost of such a procedure.

### SUMMARY OF THE INVENTION

The present invention relates to a system and method for improving integrity and authenticity of an article utilizing secure overlays. In particular, an issuer verifies an identity of a customer and generates a digital representation of an identification document of the customer. The issuer also generates an cryptographic check sum (e.g., an encrypted digital signature) as a function of the digital representation using a predetermined cryptographic algorithm and converts the digital representation and the cryptographic check sum into an overlay to be attached on the identification document.

When the identity of the customer needs to be verified, the user converts the overlay into the cryptographic check sum and the digital representation and then checks integrity of the digital representation by validating the cryptographic check sum using the predetermined cryptographic algorithm. The user also generates a further digital representation of the identification document and compares the digital representation and the further digital representation. If (a) the integrity of the digital representation is not violated and (b) the digital representation is substantially similar to the further digital representation, then an indication is generated indicating that the customer is verified.

### BRIEF DESCRIPTION OF DRAWINGS

FIG. 1 shows an exemplary system according to the present invention;

FIG. 2 shows an exemplary identification document of a customer according to the present invention;

FIG. 3 illustrates a first part of an exemplary method according to the present invention; and

FIG. 4 illustrates a second part of an exemplary method according to the present invention.

### DETAILED DESCRIPTION

The present invention relates to a system and method for enhancing authenticity and assuring integrity of information contained on a particular article (e.g., an identification document) by utilizing a security overlay that may be deployed incrementally to existing articles.

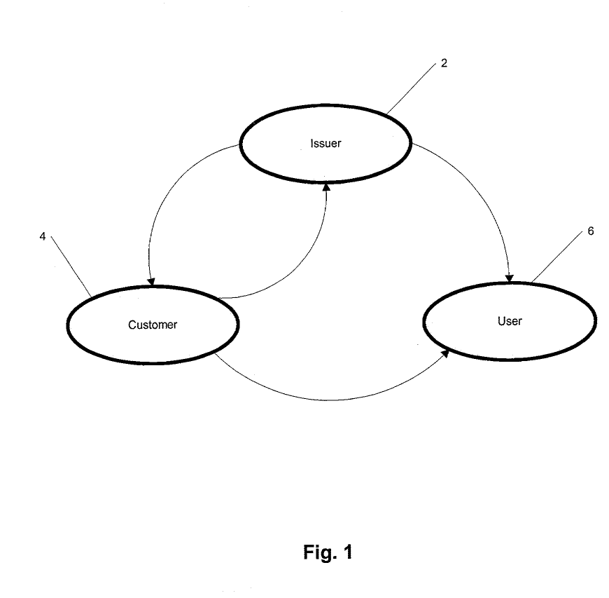

FIG. 1 shows an exemplary system according to the present invention which may include an issuer 2, a customer 4 and a user 6. The issuer 2 is an entity which performs a verification procedure to confirm the identity of the customer 4 and issue a security overlay. The customer 4 may be a person or an entity whose identity needs to be verified every time it utilizes the services of the user 6. The user 6 may be an entity (e.g., a bank, a cash checking store, a retail store, an airline passenger verification entity, etc.) which needs to verify the identity of the customer 4 before it allows the customer 4 to utilize its services or receive payments. Thus, the issuer 2 services as “a clearing house” for the user 6 who may or may not have the capability to do a thorough and quick verification procedure of the customer 4.

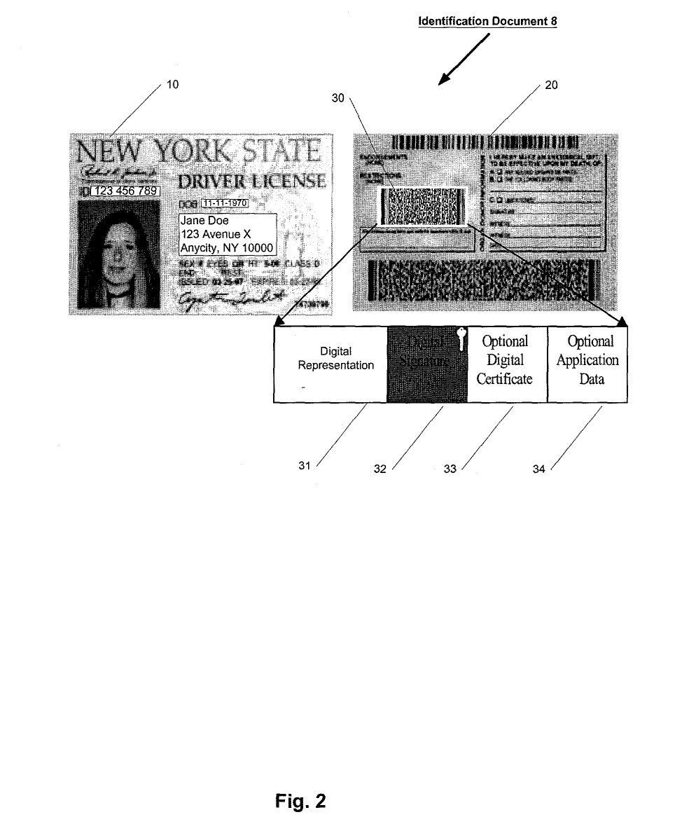

FIG. 2 shows an exemplary identification document 8 of the customer 4. The identification document 8 may be a driver license issued by a local Department of Motor Vehicles (“DMV”), a passport issued by the State Department, etc. Such identification documents 8 are commonly recognized as the most acceptable forms of identification by law enforcement, retailers, financial institutions, airlines, employers and many other entities. They have a high degree of public confidence and acceptance. However, the problem is that it may be difficult for the user 6 to visually detect fraudulent identification documents 8. One of the reasons is that certain users 6 do not have sufficient technical capability or training to identify fraudulent identification documents 8 which often cause significant financial losses or serious security breaches.

As shown in FIG. 2, the identification document 8 may have a front portion 10 and a back portion 20. The front portion 10 may include the customer's photo, name, address, date of birth, serial number, and other information. The back portion 20 may include a bar code corresponding to the serial number of the identification document 8.

The system and method according to an exemplary embodiment of the present invention may allow the strengthening of the security of the identification document 8. In particular, the issuer 2 verifies the identity of the customer 4 and issues an overlay 30 (e.g., a sticker with a two-dimensional symbology PDF417 as described at www.pdf417.com) having including a cryptographic check sum. Subsequently, the user 6 may quickly verify the identity of the customer 4 using the overlay 30.

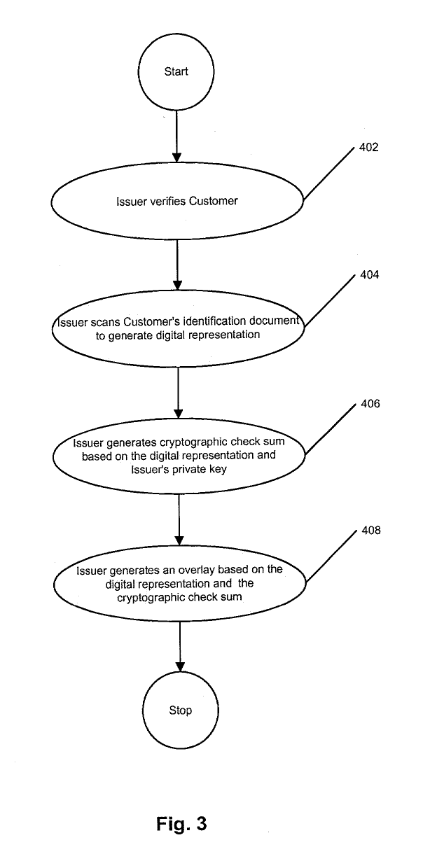

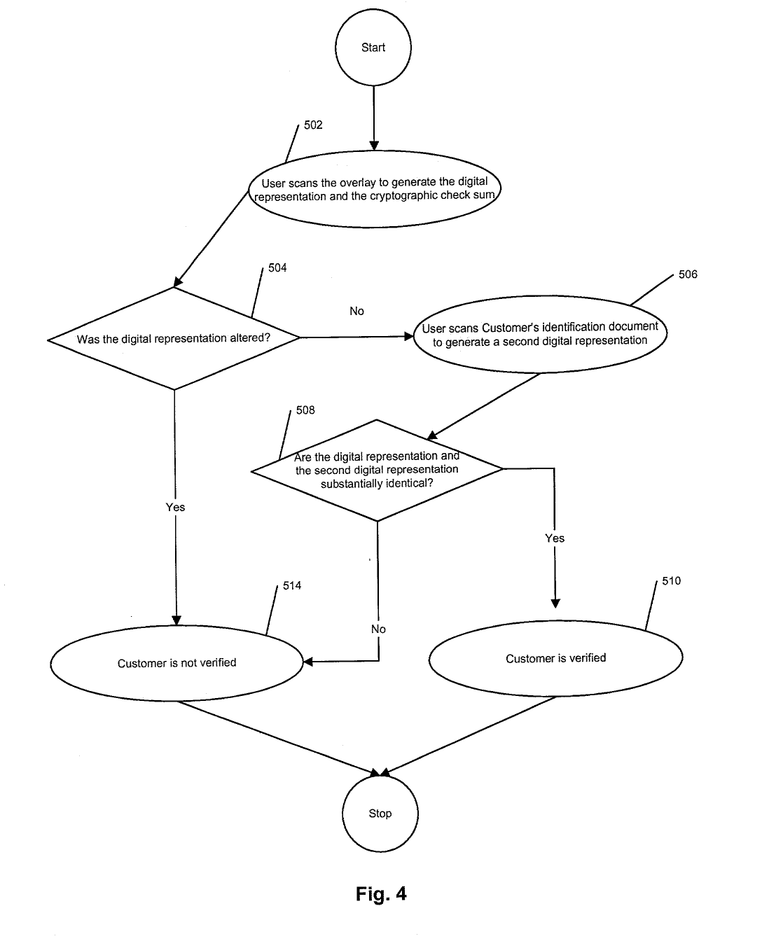

FIGS. 3 and 4 shows an exemplary method according to the present invention. In step 402, shown in FIG. 3, the issuer 2 performs a verification procedure of the customer 4 and his identification document 8. The verification procedure may include requesting a plurality of identification documents 8 of the customer 4, checking the identification documents 8 with agencies that issued these documents 8 (e.g., DMV), verifying any security features of such identification documents 8 (e.g., hidden watermarks), questioning the customer 4 regarding information indicated in such documents, etc. In addition, the verification procedure may have different levels of scrutiny depending on predetermined conditions. For example, if the user 6 is a governmental agency, such as the Federal Aviation Agency (“FAA”), the level of scrutiny may be higher then if the user 6 is a local retail store.

In step 404, the issuer 2 scans/captures predetermined data of the identification document 8, using a scanning/imaging arrangement, to generate a digital representation 31. The scanning/imaging arrangement (not shown) may be a conventional scanner capable of converting an image into the digital representation 31. In certain cases, the scanning/imaging arrangement may compress the image to generate the digital representation 31 of a desired size.

The selected data should include information sufficient to identify the customer 4 carrying the identification document 8. The selected data may be, for example, text information of the identification document 8, photo or pixel characteristics of the identification document 8, etc. The selected data may also depend upon particular usage of the identification document 8. For example, in certain cases the selected data may be just a serial number of the identification document 8; in other cases, where there is higher security demands, the selected data may be the entire identification document 8 along with other identification documents 8. For certain industries, it may be important to standardize the data selection process, i.e., creating uniform requirements that define what is sufficient data for identification (e.g., photo of the customer 4).

Subsequently, the issuer 2 generates a cryptographic check sum 32 (e.g., a digital signature) based on (1) the digital representation 31 and (2) a private key of the issuer 2 (step 406). The cryptographic check sum 32 may be based on any conventional digital signature technologies, such as RSA digital signature, Digital signature algorithm (DSA), or Elliptic Curve Digital Signature Algorithm (ECDSA), as specified in FIPS PUB 186-2 (available at

http://csrc.nist.gov/publications/fips/fips186-2/fips186-2.pdf).

It may also be based on any conventional message authentication codes, such as HMAC (available at

http://csrc.nist.gov/publications/drafts/dfips-HMAC.pdf) although the key management issue could be more complex. Those skilled in the art would understand that other cryptographic algorithms may be utilized as alternatives.

Then, in step 408, the issuer 2 generates the overlay 30 which corresponds to at least the digital representation 31 and the cryptographic check sum 32. In particular, the digital representation 31 and the cryptographic check sum 32 are converted into the two-dimensional symbology (e.g., a bar code) which can be printed on a conventional label sticker and fastened to the identification document 8. The issuer 2 may utilize a bar code generating arrangement capable of converting and printing the two-dimensional symbology. In an alternative exemplary embodiment, the reading arrangement and the bar code generating arrangement may be combined into a single arrangement. The overlay 30 may also include optional digital certificate 33 and optional application data 34, such as services allowed to use by the customer 4, if required/desired by a particular application. The optional digital certificate 33 and the optional application data 34 may be encrypted if confidentially is desired.

After the overlay 30 is placed on the identification document 8, the first part of the method is complete and any user 6 may quickly verify the identity of the customer 4 using the second part of the method. The customer 4 present the identification document 8 to the particular user 6. In step 502, shown in FIG. 4, the user 6 scans/captures the overlay 30 using a scanning/imaging arrangement (e.g., a bar code reader). The overlay 30 is decoded into the digital representation 31 and the cryptographic check sum 32. The user 6 may then verify the integrity of the digital representation 31 with the cryptographic check sum 32 (step 504). In particular, the cryptographic check sum 32 is decoded using, e.g., the issuer 2's public key. The information stored in the cryptographic check sum 32 is used to verify whether the data stored in the digital representation 31 was altered and/or tampered in any way. If there were some alterations of the digital representation 31, then a message is generated to the user 6 that the customer 4 is not verified (step 514).

In step 506, the user 6 scans the selected data of identification document 8 using the reading arrangement to generate a second digital data file. The user 6 may then compare the digital representation 31 to the second digital data file (step 508). If the two representations are substantially identical, then the customer 4 is verified (step 510); otherwise a message is generated that the customer 4 is not verified (step 514).

As mentioned above the two files may be substantially identical since the scanning processes may have some imperfections. For example, the user 6 may set a predetermined threshold for customer's verification (e.g., as long as the two file are 96% identical, the customer 4 is verified). The acceptable deviation may vary depending on the level of security desired by the user 6 and quality of equipment available to the issuer 2 and the user 6. In certain case, the acceptable deviation may vary based on the national level of security thereat. For instance, if there is “a red alert” issued, then the acceptable deviation automatically increases to 98%; while the acceptable deviation may be 90% if there is “a green alert”.

There are a number of industries that may utilize the present invention. For example, for the check-cashing application, a security service provider (SSP) may offer to serve as the trusted entity for all check-cashing stores who sign on for its service. The SSP would be responsible for securing its private key used to sign the license overlays, and it may also maintain Certificate Authorities (CA) for large systems. The SSP may offer the enrollment service to issue the overlay sticker at its location or remotely at the check-cashing stores which have to send necessary information to the SSP via secure network connections. The integrity of the enrollment is achieved by checking against the DMV database (SSP can serve as the single point of contact), and conducting detailed checks on the person and the license based on predefined procedures. Once users are enrolled, check cashing stores can verify the integrity of the driver license automatically and efficiently every time the user cashes a check.

Another example is an automotive industry. The American Association of Motor Vehicle Administrators (“AAMVA ”) is addressing the security issue relates to driving licenses by developing new standards and calling for new systems to enhance the security of driving licenses. However, it may take a long period of time to update or replace the current system. One of the advantages of the present invention is that it allows to utilize existing driver licenses, and may be implemented immediately on small or large scales. The trusted entity may be the DMV, the application providers (check-cashing businesses, airlines), or a third party providing services for certain applications.

In an alternative exemplary embodiment of the present invention, the identification document 8 may be a smart card. The digital representation of the customer 4 is prestored in the smart card 8. The issuer 2 verifies the customer 4 and reads the digital representation from the smart card 8 using the reading arrangement (e.g., a smart card reader). The issuer 2 then generates a cryptographic check sum based on issuer's private key and the digital representation. Subsequently, an overlay 30 is generated which includes the cryptographic check sum and the digital representation. The issuer 2 may further encrypt the digital representation before generating the overlay 30.

The user 6 may not need the smart card reader. The user 6 scans the overlay 30 to generate the digital representation and the cryptographic check sum. If the cryptographic check sum was not altered, then the customer 4 is verified and the digital representation is utilized by the user 6, e.g., as identification of the customer 4. Those skilled in the art would understand other types digital media may be utilized.

One of the advantages of the present invention is that the system is not required to have a display, simply an indicator that the information contained on the overlay 30 is intact and issued by the issuer 2 represented. This simplifies the device-and offers to the user 6 an extremely high degree of confidence that the information contained on the overlay 30 is genuine. The overlays 30 are easily printed on a film like material that is appended to the identification document 8. The material for the overlays 30 is inexpensive and may be removed or discarded at any time. Multiple overlays 30 may be appended representing multiple issuers 2. The scope of the issuer 2 may be extremely small (e.g. a small check cashing operation, local store, etc.) enabling readily manageable, closed Public Key Infrastructure (“PKI”) systems to be used. The scope may also be larger (DMV, INS, etc.) requiring a more elaborate PKI infrastructure.

There are many modifications to the present invention which will be apparent to those skilled in the art without departing form the teaching of the present invention. The embodiments disclosed herein are for illustrative purposes only and are not intended to describe the bounds of the present invention which is to be limited only by the scope of the claims appended hereto.

What is claimed is:

1. A method comprising the step of:
(a) verifying an identity of a customer;
(b) generating a digital representation of an identification document of the customer;
(c) generating an cryptographic check sum as a function of the digital representation using a predetermined cryptographic algorithm; and
(d) converting the digital representation and the cryptographic check sum into an overlay to be attached on the identification document.

2. The method according to claim 1, further comprising the steps of:
(e) converting the overlay into the cryptographic check sum and the digital representation;
(f) checking integrity of the digital representation by decrypting the cryptographic check sum using a predetermined decrypting technology;
(g) generating a further digital representation of the identification document;
(h) comparing the digital representation and the further digital representation;
wherein if (a) the integrity of the digital representation is not violated and (b) the digital representation is substantially similar to the further digital representation, generating an identification of that the customer is verified.

3. The method according to claim 2, wherein the steps (a)-(d) are performed by an issuer.

4. The method according to claim 3, wherein the identification document includes a plurality of overlays, each overlay being issued by a corresponding issuer.

5. The method according to claim 1, wherein the step (a) includes a plurality of levels of scrutiny based on predetermined conditions.

6. The method according to claim 1, wherein the step (b) includes the following substep:
capturing the identification document using a capturing arrangement to generate the digital representation.

7. The method according to claim 6, wherein the capturing arrangement includes at least one of a scanner and an imager.

8. The method according to claim 6, wherein the capturing arrangement compresses the digital representation to a predetermined size.

9. The method according to claim 6, wherein the step (b) includes the following substeps:
selecting predetermined data of the identification document, and
capturing the selected predetermined data to generate the digital representation.

10. The method according to claim 1, wherein the cryptographic check sum is a digital signature.

11. The method according to claim 10, wherein the cryptographic check sum is a keyed message authentication code.

12. The method according to claim 1, wherein the overlay includes optional digital certificate and optional application data.

13. The method according to claim 12, further comprising the step of:
encrypting the optional digital certificate and the optional application data.

14. The method according to claim 1, wherein the overlay is a two-dimensional symbology.

15. The method according to claim 3, wherein the steps (e)-(h) are performed by a user.

16. The method according to claim 2, wherein the step (e) is performed using an imaging arrangement.

17. The method according to claim 16, wherein the scanning arrangement includes a two-dimensional bar code reader.

18. A system comprising:
a first arrangement generating a digital representation of an identification document of a customer after an identify of the customer is verified, the first arrangement generating an cryptographic check sum as a function of the digital representation using a predetermined cryptographic algorithm, the first arrangement converting the digital representation and the cryptographic check sum into an overlay to be attached on the identification document; and
a second arrangement converting the overlay into the cryptographic check sum and the digital representation, the second arrangement checking integrity of the digital representation by decrypting the cryptographic check sum using a predetermined decrypting technology, the second arrangement generating a further digital representation of the identification document, the second arrangement comparing the digital representation and the further digital representation,
wherein, if (a) the integrity of the digital representation is not violated and (b) the digital representation is substantially similar to the further digital representation, the second arrangement generates an indication that the customer is verified.

19. The system according to claim 18, wherein the first arrangement includes a computing device, a reader arrangement and a bar code generator.

20. The system according to claim 18, wherein the second arrangement includes a computing device and a bar code reader.

21. The system according to claim 18, wherein the overlay is a two-dimensional symbology.

22. The system according to claim 18, wherein at least one of the first arrangement and the second arrangement is a hand-held device.

23. A method comprising the step of:
(a) verifying an identity of a customer;
(b) reading a digital representation of an identification document of the customer from a recordable digital media;
(c) generating an cryptographic check sum as a function of the digital representation using a predetermined cryptographic algorithm; and
(d) converting the digital representation and the cryptographic check sum into an overlay to be attached to the recordable digital media.

24. The method according to claim 1, further comprising the steps of:
(e) converting the overlay into the cryptographic check sum and the digital representation;
(f) checking integrity of the digital representation by decrypting the cryptographic check sum using a predetermined decrypting technology;
wherein if the integrity of the digital representation is not violated, an identification that the customer is verified.
